(19) United States
(12) Patent Application Publication
(10) Pub. No.: US 2015/0046988 A1
(43) Pub. Date: Feb. 12, 2015

(54) SYSTEM, CONTROL METHOD THEREFOR, AND NON-TRANSITORY COMPUTER-READABLE MEDIUM

(71) Applicant: CANON KABUSHIKI KAISHA, Tokyo (JP)

(72) Inventor: Kentaro Suzuki, Saitama-shi (JP)

(21) Appl. No.: 14/338,367

(22) Filed: Jul. 23, 2014

(30) Foreign Application Priority Data
Aug. 6, 2013 (JP) 2013-163647

(51) Int. Cl. H04L 29/06; H04L 12/58

(52) U.S. Cl. CPC H04L 63/08; H04L 51/12; H04L 51/08
USPC 726/6

(57) ABSTRACT

A system comprises: a management unit which manages, in an authentication server, user identification information and a mail address; a send unit which sends authorization information including identification information of the user from an authentication server if a user is authenticated; a reception unit which, upon receiving a request of the service together with the authorization information at an service server, receives a mail send request associated with the service and the identification information included in the authorization information from the service server at a mail send server; a specifying unit which, in response to reception of the mail send request associated with the service, specifies a mail address associated with the identification information included in the authorization information by inquiring of the authentication server; and a mail send unit which sends mail to the specified mail address.

### BACKGROUND OF THE INVENTION

1. Field of the Invention

The present invention relates to a system, a control method therefor, and a non-transitory computer-readable medium.

2. Description of the Related Art

In recent years, a system operating in a cloud environment where a plurality of servers cooperate with each other to provide various functions to a user has become widespread. One of the functions is a function of sending mail to a user. As a mail send example, a cloud system may send mail including only text to the user, or send mail attached with an electronic file.

As a conventional technique, Japanese Patent Laid-Open No. 2012-65303 discloses a system for sending an electronic file by mail.

In the conventional technique, a mail send request source needs to designate a mail address as a mail send destination. In a system in a cloud environment where a plurality of servers cooperate with each other, when implementing the mail function, it is desirable in terms of security that only a server (to be referred to as a mail send server hereinafter) for providing a mail send function can obtain a mail address as personal information. However, there was no mechanism of sending mail from a client server without notifying a mail send request source server (to be referred to as a client server) other than a mail send server of a mail address.

### SUMMARY OF THE INVENTION

According to one aspect of the present invention, there is provided a system including a service server configured to provide a service, a mail send server configured to send mail, and an authentication server configured to perform authentication processing to use the service, comprising: a management unit configured to manage, in the authentication server in association with each other, user identification information and a mail address which are used in the system; a send unit configured to, if a user is authenticated by the authentication processing, send authorization information including user identification information of the user from the authentication server; a reception unit configured to, upon receiving a request of the service together with the authorization information at the service server, receive a mail send request associated with the service and the user identification information included in the authorization information from the service server at the mail send server; a specifying unit configured to, in response to reception of the mail send request associated with the service by the reception unit, specify a mail address associated with the user identification information included in the authorization information by inquiring of the authentication server; and a mail send unit configured to send mail from the mail send server to the mail address specified by the specifying unit.

According to another aspect of the present invention, there is provided a control method for a system including a service server configured to provide a service, a mail send server configured to send mail, and an authentication server configured to perform authentication processing to use the service, the method comprising: a management step of managing, in the authentication server in association with each other, user identification information and a mail address which are used in the system; a send step of, if a user is authenticated by the authentication processing, sending authorization information including user identification information of the user from the authentication server; a reception step of, upon receiving a request of the service together with the authorization information at the service server, receiving a mail send request associated with the service and the user identification information included in the authorization information from the service server at the mail send server; a specifying step of, in response to reception of the mail send request associated with the service in the reception step, specifying a mail address associated with the user identification information included in the authorization information by inquiring of the authentication server; and a mail send step of sending mail from the mail send server to the mail address specified in the specifying step.

According to another aspect of the present invention, there is provided a non-transitory computer-readable medium storing a program for causing each computer, as each server in a system including a service server configured to provide a service, a mail send server configured to send mail, and an authentication server configured to perform authentication processing to use the service, to function as a management unit configured to manage, in the authentication server in association with each other, user identification information and a mail address which are used in the system, a send unit configured to, if a user is authenticated by the authentication processing, send authorization information including user identification information of the user from the authentication server, a reception unit configured to, upon receiving a request of the service together with the authorization information at the service server, receive a mail send request associated with the service and the user identification information included in the authorization information from the service server at the mail send server, a specifying unit configured to, in response to reception of the mail send request associated with the service by the reception unit, specify a mail address associated with the user identification information included in the authorization information by inquiring of the authentication server, and a mail send unit configured to send mail to the mail address specified by the specifying unit.

It is possible to send mail by receiving user identification information as a mail destination from a mail send request source in addition to a mail address.

Further features of the present invention will become apparent from the following description of exemplary embodiments (with reference to the attached drawings).

### BRIEF DESCRIPTION OF THE DRAWINGS

FIG. 1 is a view showing an example of the configuration of a system;

FIG. 2 is a block diagram showing an example of a hardware arrangement;

FIG. 3 is a block diagram showing an example of a software arrangement;

FIGS. 4A and 4B are tables for managing user information and group information, respectively;

FIG. 5 is a view showing an example of a login screen;

FIG. 6 is a flowchart illustrating processing of obtaining the user ID of a login user;

FIG. 7 is a flowchart illustrating processing of obtaining the user IDs of users other than the login user;

FIG. 8 is a flowchart illustrating file-attached mail send processing;

FIG. 9 is a flowchart illustrating processing of obtaining a mail address corresponding to the user ID;

FIGS. 10A, 10B, and 10C are views each showing an example of a mail send screen;

FIG. 11 is a table for managing mail server information according to the second embodiment;

FIG. 12 is a table for managing file information according to the second embodiment;

FIG. 13 is a flowchart illustrating processing of switching between file-attached mail and mail describing a file storage destination URL, and sending the mail according to the second embodiment;

FIG. 14 is a flowchart illustrating file download processing according to the second embodiment;

FIG. 15 is a view showing an example of a file download screen according to the second embodiment;

FIG. 16 is a table for managing a mail send history according to the third embodiment;

FIGS. 17A and 17B are tables for managing send disable data sizes before and after update for each mail address domain according to the third embodiment;

FIG. 18 is a flowchart illustrating file-attached mail send processing according to the third embodiment; and

FIG. 19 is a flowchart illustrating send processing of mail having a size exceeding the send allowable data size of a mail server according to the third embodiment.

### DESCRIPTION OF THE EMBODIMENTS

Modes for carrying out the present invention will be described below with reference to the accompanying drawings.

### First Embodiment

### System Configuration

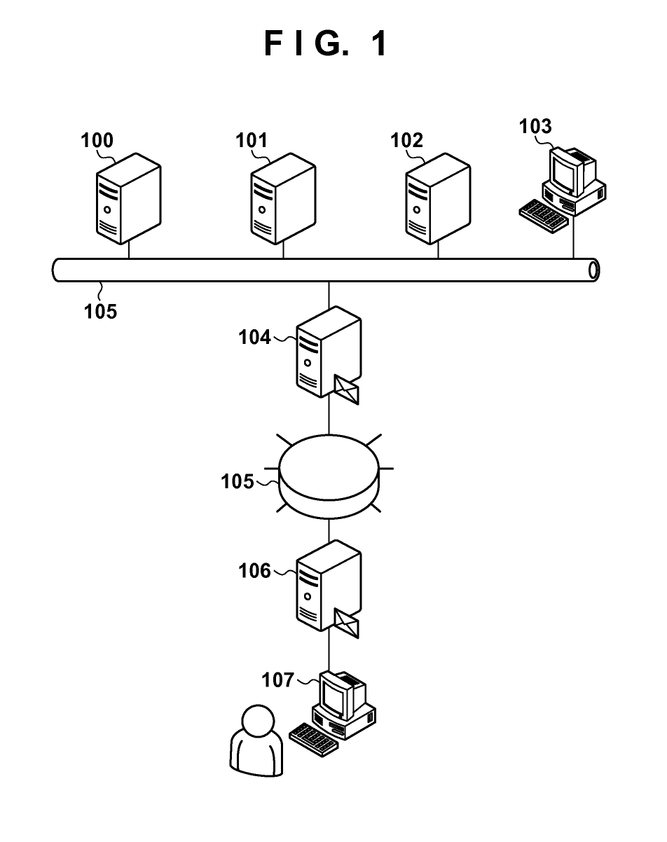

FIG. 1 is a schematic view showing a system according to the present invention. The system of this embodiment includes a mail send server 100, a client server 101, an authentication server 102, a client PC 103, and a mail server 104. The respective servers are connected to each other via a network 105 such as the Internet. Although not shown, there may exist a plurality of client servers 101 and a plurality of client PCs 103. Note that in this embodiment, the client server 101 also functions as a service server for providing an arbitrary service other than a mail send service, in response to a user request.

The sequence of basic mail send processing according to this embodiment will be explained. The mail send server 100 collectively performs mail send processes in the system and, in response to a mail send request issued in the system, generates mail to be sent. The mail send server 100 issues a request to send the generated mail to the mail server 104. The mail server 104 specifies an external mail server 106 as a transfer destination based on a destination mail address, and transfers the mail. The recipient of the mail uses a computer 107 such as a PC or mobile device to inquire of the external mail server 106 mail destined for the recipient, thereby receiving the mail.

[Hardware Arrangement]

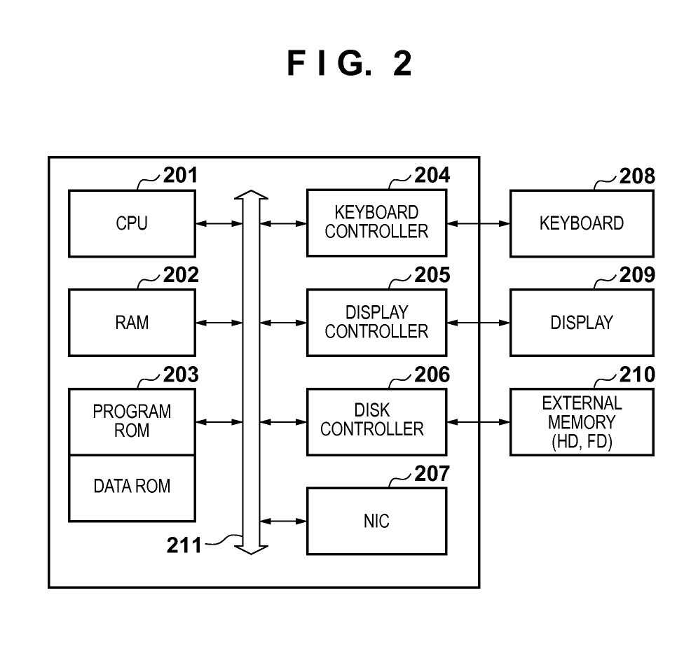

FIG. 2 shows an example of the hardware arrangement of each PC forming the system according to the embodiment of the present invention. The hardware arrangement shown in FIG. 2 corresponds to that of a general information processing apparatus, and the hardware arrangement of the general information processing apparatus is applicable to each PC of the embodiment.

Referring to FIG. 2, a CPU 201 executes a program such as an OS (Operating System) or application stored in a program area of a ROM 203 or loaded from an external memory 210 into a RAM 202. Processing shown in each flowchart (to be described later) is implemented when the CPU 201 of each apparatus executes a program according to the present invention.

The RAM 202 functions as a main memory, a work area, and the like for the CPU 201. A keyboard controller 204 controls key inputs from a pointing device (not shown) such as a keyboard 208 or mouse. A display controller 205 controls display on a display 209 serving as a display device. A disk controller 206 controls data access in the external memory 210 such as a hard disk (HD) for storing various data.

A NIC 207 serves as a network interface, and is connected to the network 105 to execute communication control processing with another device connected to the network. The hard disk (HD) 210 stores programs such as an OS and applications, and also stores various files under the management of the OS which forms a file system. An interconnection bus 211 intermediates communication between blocks by the CPU 201.

[Software Arrangement]

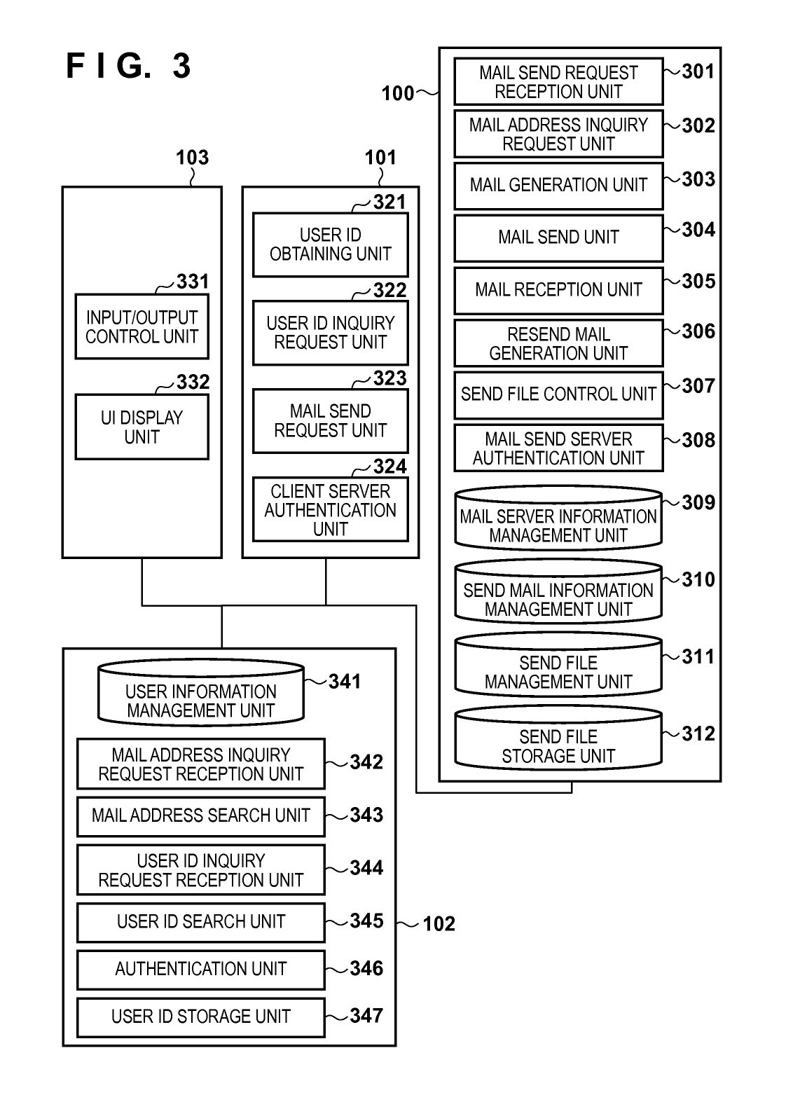

FIG. 3 is a block diagram showing the software module arrangement of the system. Each process to be described below is implemented by loading a program recorded in the hard disk (HD) 210 into the RAM 202, and executing the program by the CPU 201. The system formed by the mail send server 100, client server 101, and authentication server 102, which are shown in FIG. 3, will be referred to as a “mail send system” hereinafter.

Each unit of the mail send server 100 will be described first. A mail send request reception unit 301 receives a mail send request from a mail send request source (the client server 101 in this embodiment). The received information includes a mail destination, mail contents (subject, text, and the like), and a file to be sent. As the format of the mail destination, user identification information (to be referred to as a user ID hereinafter) for identifying the user of the mail send system is received. To allow sending of mail to a mail address which is not managed by the authentication server 102 (that is, which is not registered in the mail send system), a mail address is also received as the format of the mail destination. A user information management unit 341 (to be described later) of the authentication server 102 collectively manages pieces of information about the user such as a user ID.

A mail address inquiry request unit 302 requests the authentication server 102 to obtain a mail address set in the user ID designated as the mail destination. A mail generation unit 303 uses the mail contents and the send target file to generate mail to be sent. At this time, the mail generation unit 303 sets, as a destination, the mail address received from the client server 101 or obtained from the authentication server 102. A mail send unit 304 requests the mail server 104 to send the generated mail.

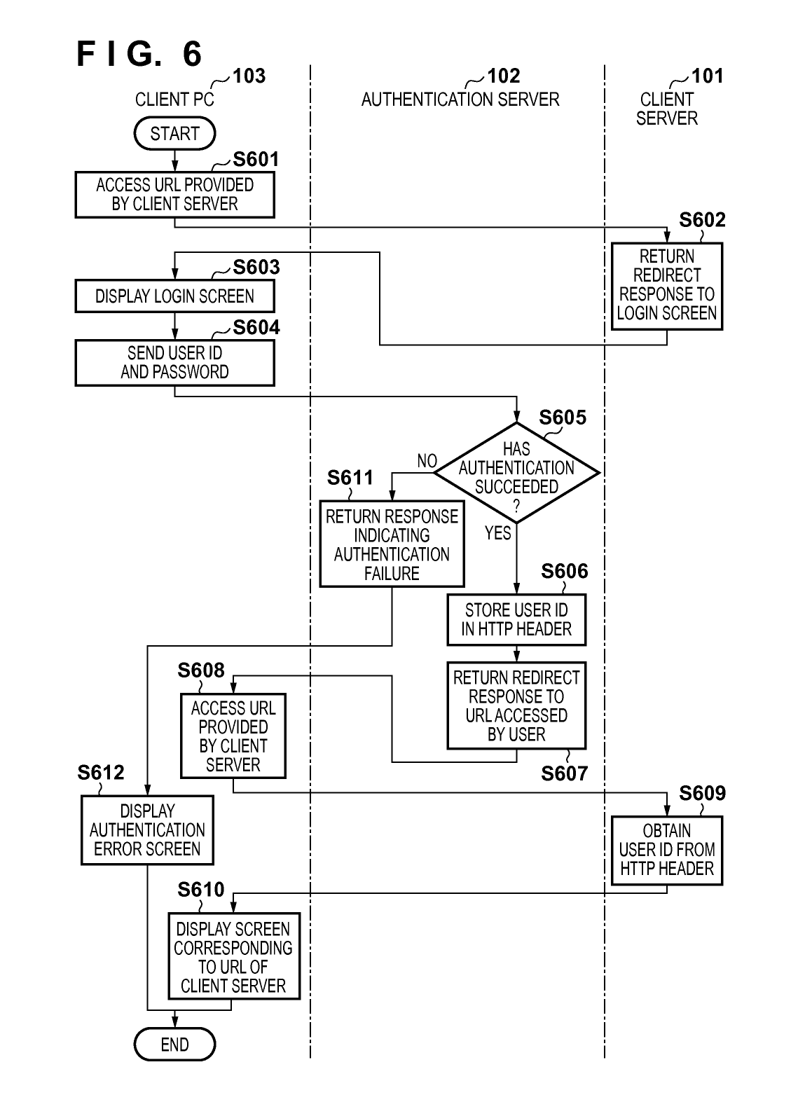

Each unit of the client server 101 will be described next. A user ID obtaining unit 321 obtains, from an http header, the user ID of the user who has logged in to the mail send system. The user ID obtaining processing will be described later with reference to FIG. 6.

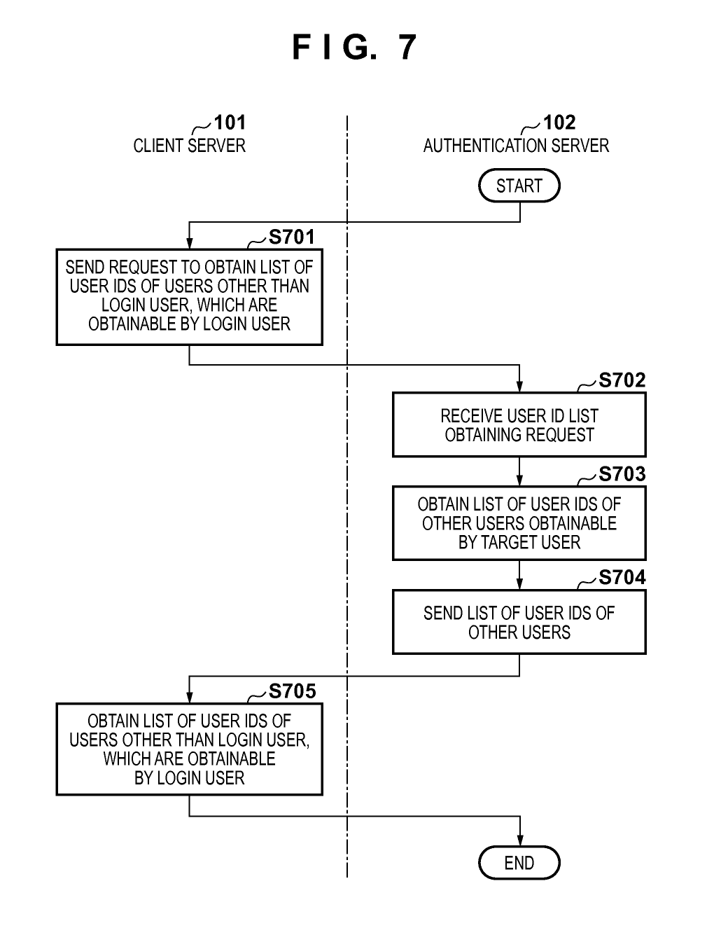

A user ID inquiry request unit 322 requests the authentication server 102 to obtain a list of the user IDs of other users, which are obtainable by the login user of the mail send system. The processing of obtaining a list of the user IDs of other users will be described later with reference to FIG. 7. A mail send request unit 323 issues a mail send request to the mail send server 100. Assume that the mail send request contains a mail destination (the user ID format or mail address format), mail contents (subject and text), and a file to be sent.

When a user who has not logged in to the mail send system accesses a URL (Uniform Resource Locator) provided by the client server 101, a client server authentication unit 324 redirects the access to the login screen of the authentication server 102.

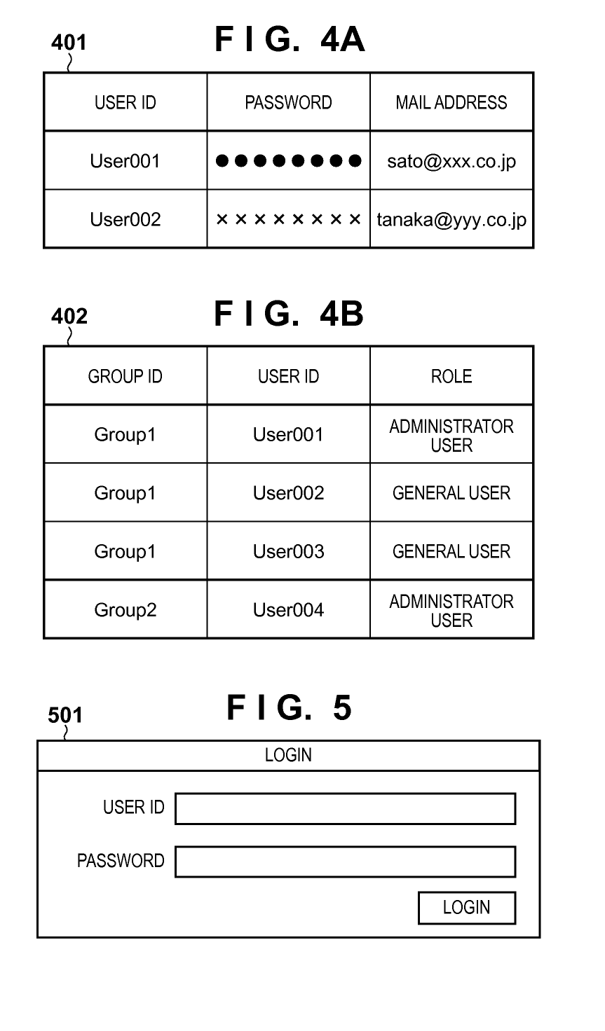

Each unit of the authentication server 102 will be described. The user information management unit 341 manages the user information of each user registered in the mail send system and information about a group to which each user belongs. More specifically, the user information management unit 341 manages the user information by associating a user ID, password, and mail address with each other, as indicated by a user information table 401 of FIG. 4A. The user ID is an identifier for uniquely identifying a user registered in the mail send system. The user information management unit 341 also manages a user belonging to a group and the role of the user in the group by associating a group ID, user ID, and role with each other, as indicated by a group information table 402 of FIG. 4B.

A mail address inquiry request reception unit 342 receives an inquiry request of a mail address set in a user ID from the mail send server 100. In the mail send system, a mail address inquiry request is not received from a server other than the mail send server 100.

A mail address search unit 343 searches the user information table 401 for a mail address associated with the target user ID of a mail address obtaining request, and obtains the mail address. The mail address search unit 343 returns, as a response, the obtained mail address to the mail send server 100 as an inquiry request source.

A user ID inquiry request reception unit 344 receives, from the client server 101, an inquiry request of a list of the user IDs of other users, which are obtainable by the login user of the mail send system.

A user ID search unit 345 searches the group information table 402 for a list of other user IDs obtainable by the target user ID, obtains the list, and returns, as a response, the obtained list to the client server 101 as an obtaining request source. In this embodiment, a user as the administrator user of a given group can obtain the user ID of each user belonging to the group. For example, as shown in FIG. 4B, a user having a user ID “User001” has a role “administrator user” in a group having a group ID “Group1”. Therefore, the administrator user can obtain the user IDs (“User002” and “User003”) of the users belonging to the same group (“Group1”).

An authentication unit 346 performs the authentication processing of the mail send system. In order for the user to log in to the mail send system, a login screen 501 shown in FIG. 5 is provided. By referring to the user information table 401, the authentication unit 346 determines whether a user ID and password input by the user are correct. If the input information is correct, the authentication unit 346 returns a response indicating authentication success; otherwise, the authentication unit 346 returns a response indicating an authentication error.

When the login authentication of the authentication unit 346 succeeds, a user ID storage unit 347 stores the user ID of the login user in the http header. The http header is a known technique and a detailed description thereof will be omitted. The http header is information used to exchange data in HTTP communication. In this embodiment, if the user ID of the user has been set in the http header, it is considered that authentication of the user has been successfully performed, and the http header is used as authorization information.

Each unit of the client PC 103 will be described. An input/output control unit 331 sends a data request to each of the client server 101 and the authentication server 102, and receives responses from them. A UI display unit 332 interprets the data of a URL provided by each of the client server 101 and authentication server 102, and displays the data on a web browser (not shown).

[Processing of Obtaining User ID of Login User]

Processing in which the client server 101 as a mail send request source obtains the user ID of the user of the mail send system will be described with reference to a flowchart shown in FIG. 6. This processing is implemented when the CPU of each apparatus reads out and executes a program stored in the ROM or the like as a storage unit.

S601: The input/output control unit 331 of the client PC 103 sends, to the client server 101, a request to access the URL provided by the client server 101, which has been input by the user.

S602: In response to reception of the access request from the client PC 103, the client server authentication unit 324 of the client server 101 returns a redirect response to the URL of a login page provided by the authentication server 102.

S603: The UI display unit 332 of the client PC 103 interprets the URL of the login screen provided by the authentication server 102 as a redirect destination, and displays the login screen 501.

S604: The input/output control unit 331 of the client PC 103 issues an authentication request to the authentication server 102 by sending a user ID and password input by the user through the login screen 501 to the authentication server 102.

S605: The authentication unit 346 of the authentication server 102 refers to the user information table 401 to determine whether the user ID and password sent in step S604 are correct, thereby performing user authentication. If authentication has succeeded (YES in step S605), the process advances to step S606; otherwise (NO in step S605), the process advances to step S611.

S606: The user ID storage unit 347 of the authentication server 102 embeds and stores, in the http header, the user ID of the user for which it is determined in step S605 that authentication has succeeded. The http header embedded with the user ID is used as authorization information.

S607: The authentication unit 346 of the authentication server 102 returns a redirect response to the URL provided by the client server 101 and accessed by the user in step S601. The provided URL may be held in advance in the authentication server 102, or information held when the client server 101 accesses the URL for the first time may be used.

S608: The input/output control unit 331 of the client PC 103 accesses the URL provided by the client server 101, redirected in step S607, and accessed by the user in step S601.

S609: The user ID obtaining unit 321 of the client server 101 obtains the user ID stored by the authentication server 102 in the http header.

S610: The UI display unit 332 of the client PC 103 displays a screen corresponding to the URL of the client server 101 accessed by the user in step S601. The processing sequence then ends.

S611: The authentication unit 346 of the authentication server 102 returns, to the client PC 103, a response indicating authentication failure.

S612: The UI display unit 332 of the client PC 103 displays an error screen indicating authentication failure. The processing sequence then ends.

[Processing of Obtaining User ID of User Other than Login User]

Processing in which the client server 101 as a mail send request source obtains the user IDs of other users, which are obtainable by the login user of the mail send system, will be described with reference to a flowchart shown in FIG. 7. Note that this processing assumes that the client server 101 has already obtained the user ID of the login user of the mail send system by the processing of obtaining the user ID of the login user shown in FIG. 6. This processing is implemented when the CPU of each apparatus reads out and executes a program stored in the ROM or the like as a storage unit.

S701: The user ID inquiry request unit 322 of the client server 101 sends, to the authentication server 102, a request to obtain a list of the user IDs of other users, which are obtainable by the login user of the mail send system.

S702: The user ID inquiry request reception unit 344 of the authentication server 102 receives the user ID list obtaining request sent by the client server 101 in step S701.

S703: By referring to the group information table 402, the user ID search unit 345 of the authentication server 102 searches for a list of the user IDs of other users, which are obtainable by the target user, and obtains the list. A case in which a list of other user IDs obtainable by the user having the user ID “User001” in the example of FIG. 4B is obtained will be explained. A group to which the user (“User001”) belongs and the role of the user in the group are determined by referring to the group information table 402. Since the user (“User001”) has the role “administrator user” in the group having the group ID “Group1”, it is possible to obtain a list of the user IDs of other users belonging to the same group (“Group1”). Since “User002” and “User003” belong to the same group (“Group1”), the respective user IDs (“User002” and “User003”) are obtained as a list of other user IDs obtainable by the user ID (“User001”).

S704: The user ID search unit 345 of the authentication server 102 sends the user ID list obtained in step S703 to the client server 101.

S705: The user ID inquiry request unit 322 of the client server 101 receives and obtains the user ID list sent by the authentication server 102 in step S704. The processing sequence then ends.

[File-Attached Mail Send Processing]

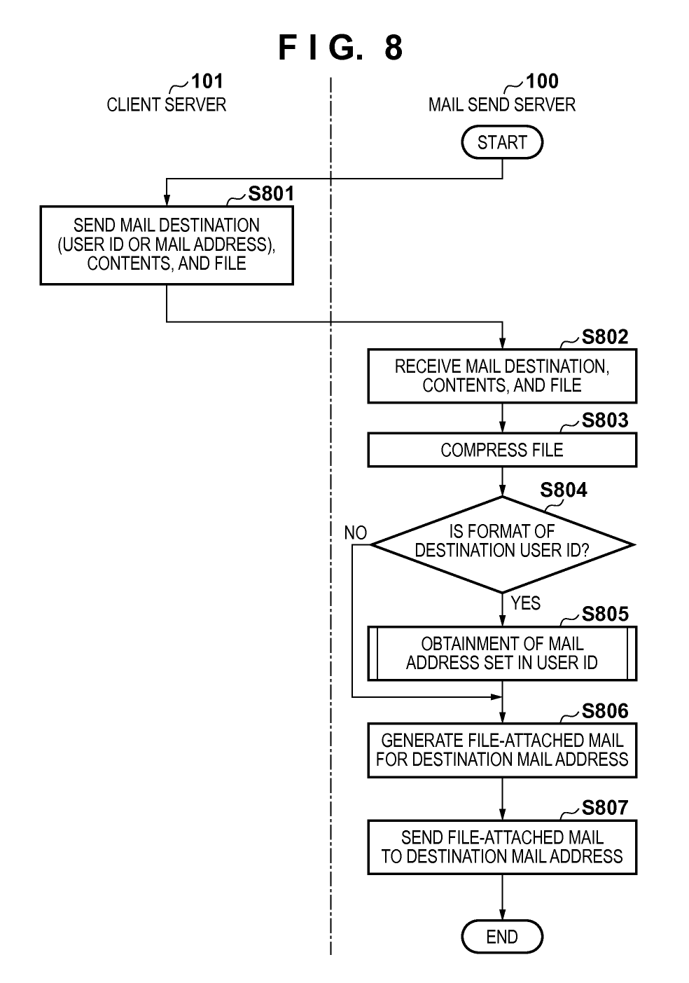

Processing in which the mail send server 100 sends file-attached mail will be described with reference to a flowchart shown in FIG. 8. This processing is implemented when the CPU of each apparatus reads out and executes a program stored in the ROM or the like as a storage unit.

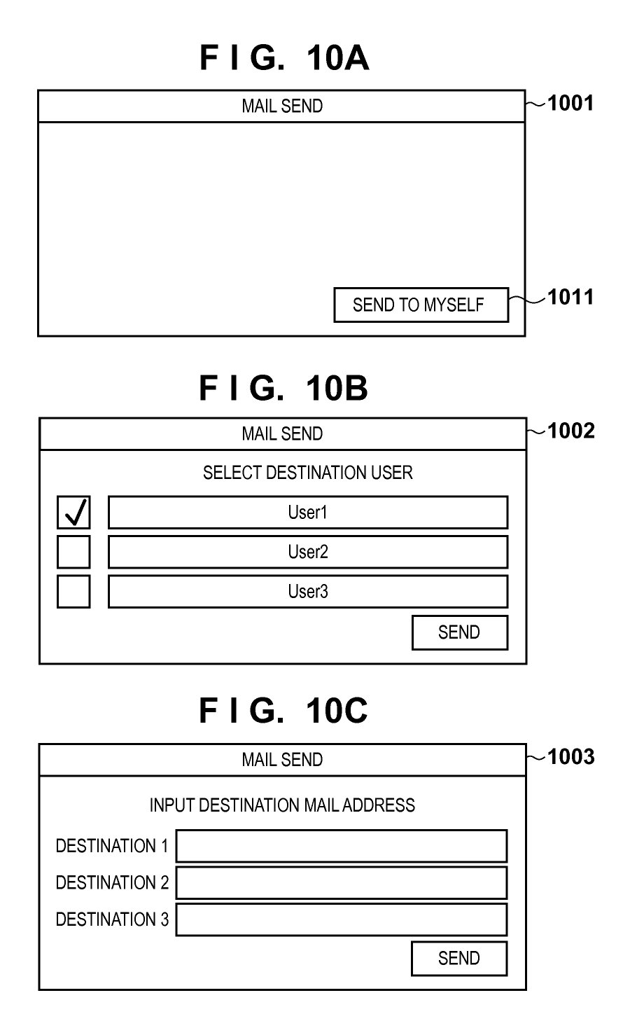

S801: The mail send request unit 323 of the client server 101 requests the mail send server 100 to send mail. The mail send request contains a mail destination (user ID or mail address), mail contents (subject and text), and a send target file. An example of designation of the mail destination will be described later with reference to FIGS. 10A to 10C.

S802: The mail send request reception unit 301 of the mail send server 100 receives the mail send request (mail destination, contents, and send target file) sent by the client server 101 in step S801.

S803: The mail generation unit 303 of the mail send server 100 compresses the send target file received in step S802.

S804: The mail generation unit 303 of the mail send server 100 determines whether the destination format is a user ID. If the destination format is a user ID (YES in step S804), the process advances to step S805. If the destination format is a mail address (NO in step S804), the process advances to step S806.

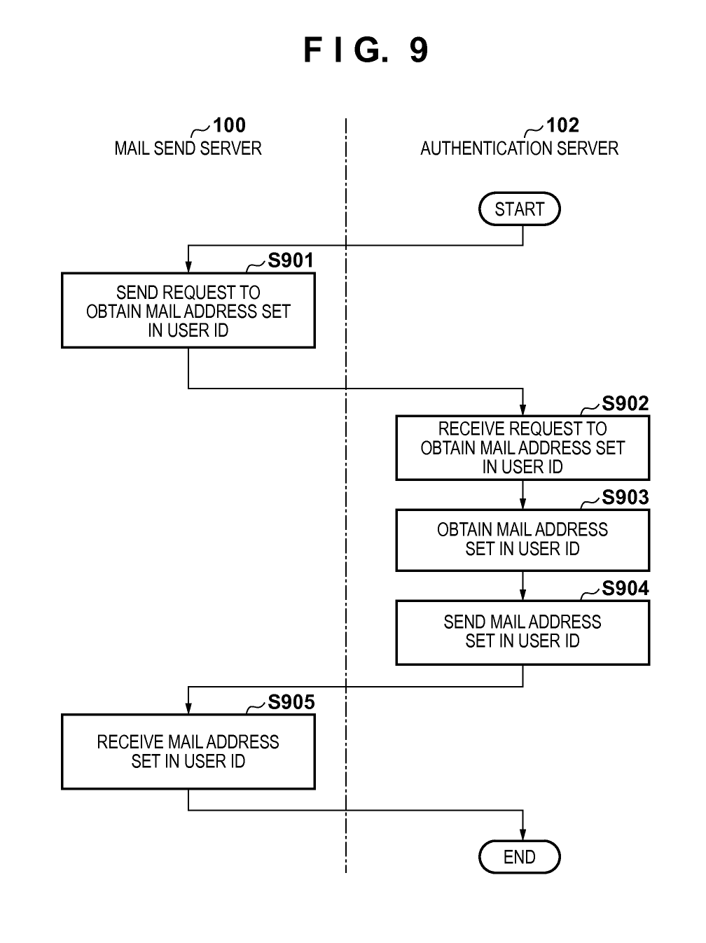

S805: The mail address inquiry request unit 302 of the mail send server 100 obtains the mail address set in the user ID designated as the mail destination. Details of the processing will be described later with reference to FIG. 9.

S806: The mail generation unit 303 of the mail send server 100 generates file-attached mail using the mail address as the mail destination, the mail contents, and the send target file.

S807: The mail send unit 304 of the mail send server 100 sends the file-attached mail to the mail address as the destination. The processing sequence then ends.

[Processing of Obtaining Mail Address Set in User ID]

The processing of obtaining a mail address set in a user ID will be described with reference to a flowchart shown in FIG. 9. This processing is implemented when the CPU of each apparatus reads out and executes a program stored in the ROM or the like as a storage unit.

S901: The mail address inquiry request unit 302 of the mail send server 100 sends, to the authentication server 102, a request to obtain a mail address set in a user ID.

S902: The mail address inquiry request reception unit 342 of the authentication server 102 receives the mail address obtaining request sent by the mail send server 100 in step S901.

S903: By referring to the user information table 401, the mail address search unit 343 of the authentication server 102 searches for a mail address set in a target user ID, and obtains the mail address. In the example shown in FIG. 4A, for example, for the user having the user ID “User001”, the mail address search unit 343 obtains a mail address (“sato@xxx.co.jp”) set in the target user ID (“User001”).

S904: The mail address search unit 343 of the authentication server 102 sends information about the mail address obtained in step S903 to the mail send server 100.

S905: The mail address inquiry request unit 302 of the mail send server 100 receives the mail address information sent by the authentication server 102 in step S904.

[Mail Send Screen]

FIGS. 10A to 10C each show an example of the mail send screen provided by the client server 101 and displayed on the UI display unit 332 of the client PC 103. That is, this screen also serves as a reception screen for receiving information about a mail destination from the user. A mail send screen 1001 shown in FIG. 10A and a mail send screen 1002 shown in FIG. 10B are examples when the mail destination is in the user ID format. On the other hand, a mail send screen 1003 shown in FIG. 10C is an example when the mail destination is in the mail address format.

The mail send screen 1001 is an example of a screen used to send mail by designating the user ID of the login user as a mail destination. Upon press of a “send to myself” button 1011 by the user, the user ID of the login user stored in the http header is set as a destination. The mail send screen 1001 is displayed when the login user of the mail send system wants to send mail to himself/herself, irrespective of whether the user is an administrator user or general user.

The mail send screen 1002 is an example of a screen used to send mail by designating, as a mail destination, the user ID of a user different from the login user. If the login user of the mail send system has the authority (for example, the administrator authority) to obtain the user IDs of other users, a list of the user IDs of other users is displayed on the screen. The user ID of a user selected by the user is set as a destination. The mail send screen 1002 is displayed when the login user of the mail send system is the administrator user of a group, and wants to send mail to another user belonging to the group.

The mail send screen 1003 is a screen used to send mail by designating an arbitrary mail address as a mail destination. A mail address input by the user is set as a destination. The mail send screen 1003 is displayed when the login user of the mail send system wants to send mail to an arbitrary mail address which is not registered in the mail send system, irrespective of whether the user is an administrator user or general user.

[Effects of First Embodiment]

It is possible to send mail by receiving user identification information as a mail destination from a mail send request source in addition to a mail address. Furthermore, it is possible to send mail without notifying a client server of a mail address, thereby improving the security of the system.

### Second Embodiment

When sending file-attached mail by the method of the first embodiment, the mail send server 100 issues a mail send request to the mail server 104. If the limit value of an attached file send allowable data size is set in the mail server 104, when the user attempts to send file-attached mail having a data size exceeding the limit value, a send error may occur and thus the mail may not be sent.

In this embodiment, a method will be described in which if an attached file has a size exceeding the limit value of the send allowable data size of a mail server 104, the actual data of the attached file is held and mail describing a file storage destination URL (position information) is sent.

[Software Arrangement]

A system configuration and hardware arrangement are the same as those in the first embodiment. A software arrangement different from that in the first embodiment will be described below.

Each unit of a mail send server 100 according to this embodiment will be explained with reference to FIG. 3. A send file control unit 307 stores a file to be sent by mail in a send file storage unit 312. The send file control unit 307 provides a screen displaying a list of files downloadable by a user who accesses a file storage destination URL.

When a user who has not logged in to a mail send system accesses the URL provided by the mail send server 100, a mail send server authentication unit 308 redirects the access to the URL of a login screen provided by an authentication server 102.

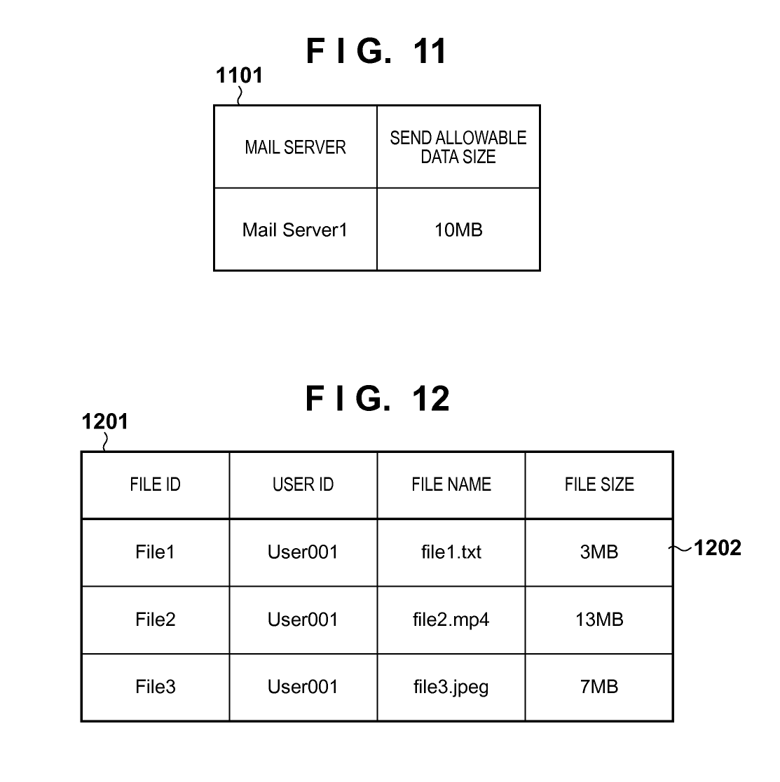

A mail server information management unit 309 manages the information of a mail server to which the mail send server 100 issues a mail send request. For example, as indicated by a mail server information table 1101 of FIG. 11, mail server identification information and the send allowable data size of a file data size which is allowed to be sent by the mail send server are managed in association with each other. The send allowable data size indicates the upper limit of the data size of an attached file which can be sent by the mail server. Note that in this embodiment, since an attached file undergoes compression processing, the data size is that after compression.

A send file management unit 311 manages information of a file to be sent by the mail send server 100. For example, as indicated by a file information management table 1201 of FIG. 12, a file ID for identifying a file, the user ID of a destination to which the file is to be sent, a file name, and the file size of the send target file are managed in association with each other. The send file storage unit 312 stores the send target file. Note that the file storage format in the send file storage unit 312 is not specifically limited.

Each unit of a client PC 103 will be described. An input/output control unit 331 sends a data request to the mail send server 100 in addition to the client server 101 and authentication server 102, and receives responses from them.

A UI display unit 332 interprets the data of a URL provided by the mail send server 100 in addition to the client server 101 and authentication server 102, and displays a web browser (not shown). Other components are the same as those in the first embodiment and a description thereof will be omitted.

[Mail Format Switching Send Processing]

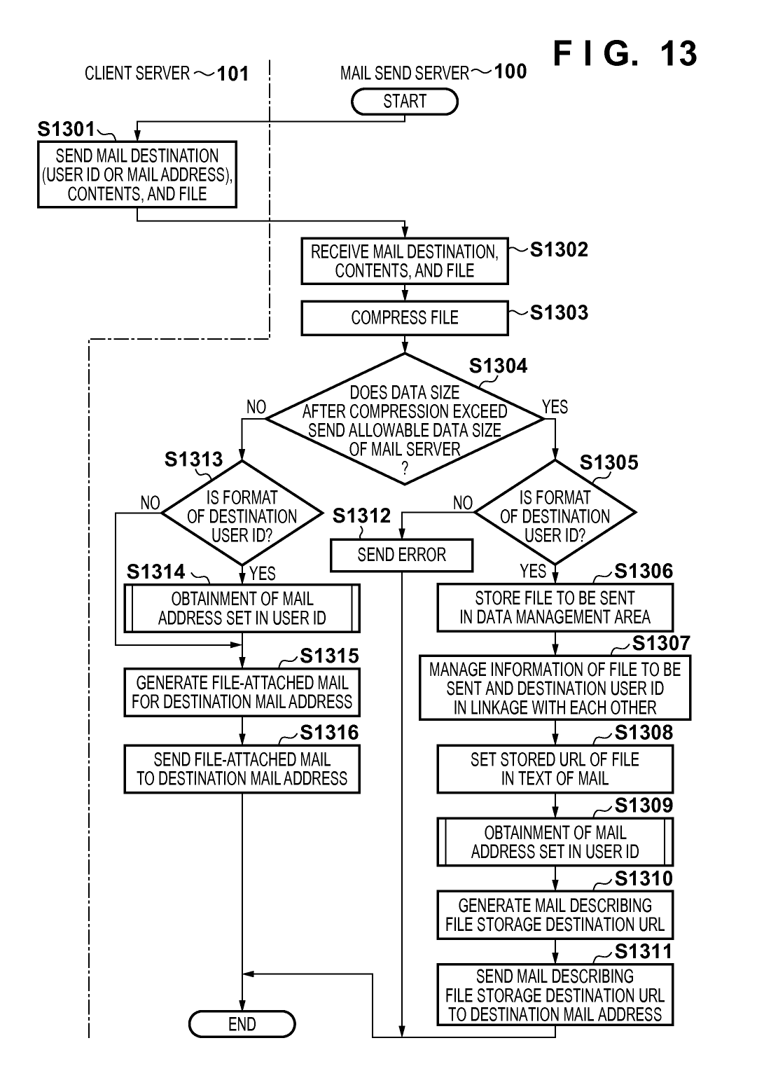

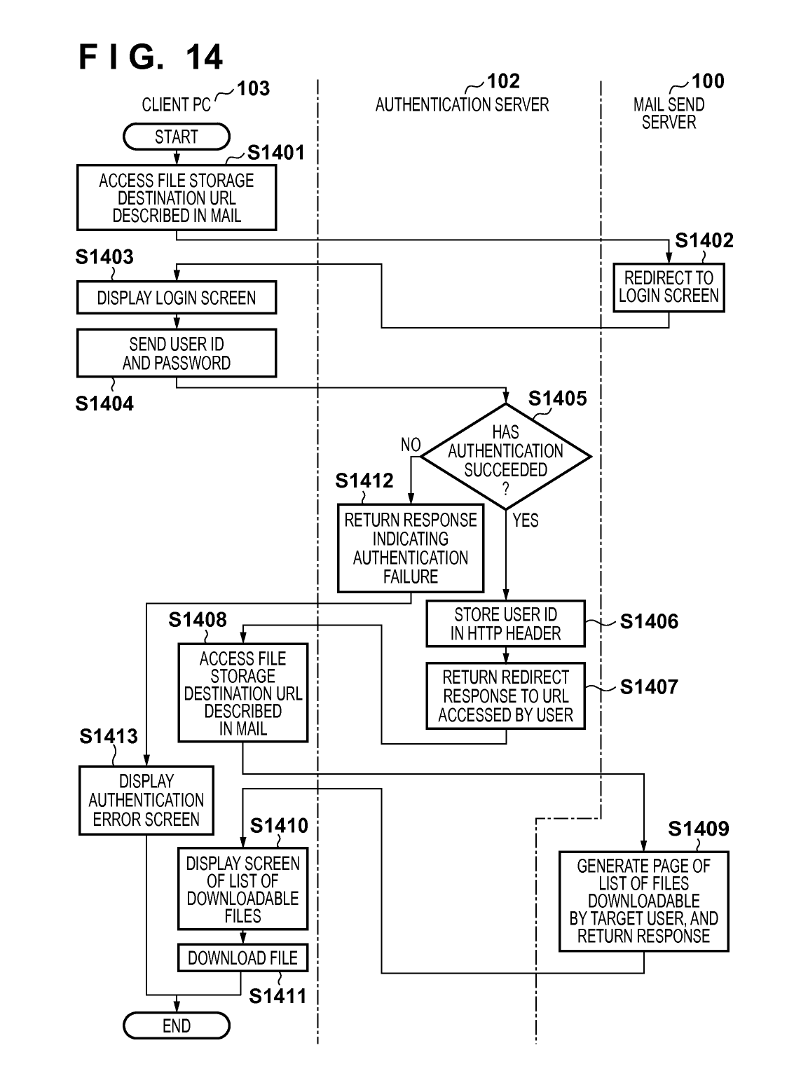

Processing in which the mail send server 100 sends a file by mail by switching between sending of file-attached mail and sending of mail describing a file storage destination URL will be described with reference to a flowchart shown in FIG. 13. Steps S1301 to S1303 are the same as steps S801 to S803 of FIG. 8 of the first embodiment and a description thereof will be omitted.

S1304: By referring to the mail server information table 1101, a mail generation unit 303 of the mail send server 100 determines whether the data size of a file compressed in step S1303 exceeds the send allowable data size of the mail server. If the data size of the file exceeds the send allowable data size (YES in step S1304), the process advances to step S1305; otherwise (NO in step S1304), the process advances to step S1313.

S1305: The mail generation unit 303 of the mail send server 100 determines whether a designated destination format is a user ID. If a user ID has been designated (YES in step S1305), the process advances to step S1306. On the other hand, if a mail address has been designated (NO in step S1305), the process advances to step S1312.

S1306: The send file control unit 307 of the mail send server 100 stores the send target file in the send file storage unit 312.

S1307: The send file control unit 307 of the mail send server 100 records, in the file information management table 1201, the information (file ID, file name, and file size) of the send target file and the user ID of the destination in association with each other. For example, file information 1202 indicates that a file having a file ID “File1” has been recorded. The file ID “File1” indicates that the user ID is “User001”, the file name is “file1.txt”, and the file size is “3 MB”.

S1308: The mail generation unit 303 of the mail send server 100 sets a file storage destination URL in the text of mail, instead of attaching the send target file to mail.

S1309: A mail address inquiry request unit 302 of the mail send server 100 obtains a mail address set in the target user ID. Processing at this time is the same as that shown in FIG. 9 of the first embodiment and a description thereof will be omitted.

S1310: The mail generation unit 303 of the mail send server 100 generates mail to be sent using a subject received in step S1302 and the text in which the file storage destination URL has been set in step S1308. The mail generation unit 303 then sets, as a destination, the mail address obtained in step S1309.

S1311: A mail send unit 304 of the mail send server 100 sends the mail generated in step S1310.

S1312: The mail generation unit 303 of the mail send server 100 determines a send error. That is, if the format of a destination received in step S1302 is a mail address, mail describing the file storage destination URL is not sent. This is because even if the file storage destination URL is sent by mail, a user who receives the mail cannot log in to the mail send system at high probability. That is, if the user cannot log in to the system, he/she cannot access the file storage destination URL. Steps S1313 to S1316 are the same as steps S804 to S807 of FIG. 8 of the first embodiment and a description thereof will be omitted.

[File Download Processing]

Processing in which when the user receives mail describing a file storage destination URL, the mail send server 100 downloads and obtains a file will be described with reference to flowchart shown in FIG. 14. The processing is implemented when the CPU of each apparatus reads out and executes a program stored in a ROM or the like as a storage unit.

S1401: The input/output control unit 331 of a client PC 103 sends, to the mail send server 100, a request to access a file storage destination URL described in received mail.

S1402: The mail send server authentication unit 308 of the mail send server 100 redirects the access from the client PC 103 to the URL of a login page provided by the authentication server 102. Processes in steps S1403 to S1406 are the same as those in steps S603 to S606 of FIG. 6 of the first embodiment and a description thereof will be omitted.

S1407: An authentication unit 346 of the authentication server 102 returns a redirect response to the URL provided by the mail send server 100 and accessed by the user in step S1401.

S1408: Redirection in step S1407 causes the input/output control unit 331 of the client PC 103 to access the file storage destination URL provided by the mail send server 100 and accessed by the user in step S1401.

S1409: The send file control unit 307 of the mail send server 100 obtains a list of files downloadable by the user. At this time, the send file control unit 307 obtains a user ID stored in the http header, and refers to the file information management table 1201 to specify the file of a file ID associated with the target user ID. The send file control unit 307 generates a page displaying a list of the specified downloadable files, returns the page to the client PC 103 as a response.

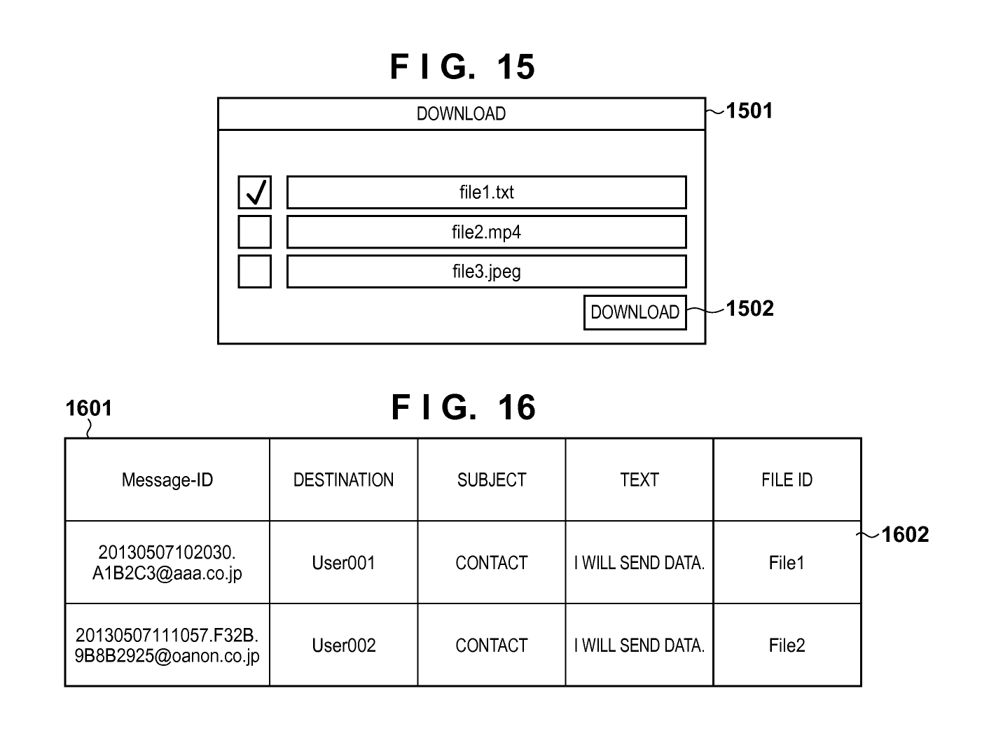

S1410: The UI display unit 332 of the client PC 103 interprets the response returned in step S1409, and displays a screen showing the list of the downloadable files like a download screen 1501 shown in FIG. 15. In the download screen 1501 of FIG. 15, the user can designate a file to be downloaded by selecting a file by a check box from the displayed file list, and pressing a download button 1502.

S1411: The send file control unit 307 of the mail send server 100 downloads the file selected by the user through the download screen 1501. Processes in steps S1412 and S1413 are the same as those in steps S611 and S612 of FIG. 6 of the first embodiment and a description thereof will be omitted.

[Effects of Second Embodiment]

In the method according to the first embodiment, even if file-attached mail having a data size exceeding the limit value of the attached file send allowable data size of the mail server 104 is sent, a send error occurs, and thus the sent mail may not reach a destination user. Therefore, the destination user may not obtain the send target file.

In the method according to this embodiment, if an attached file has a data size exceeding the send allowable data size of the mail server 104, a send file is stored in the mail send system, and mail describing a file storage destination URL is sent. A destination user accesses the file storage destination URL described in the received mail, and downloads the send target file. In addition to the effects of the first embodiment, therefore, even if an attached file has a data size exceeding the send allowable data size of the mail server 104, it is possible to send mail to a destination user, and the user can obtain the file.

### Third Embodiment

In the method of the second embodiment, file-attached mail having a data size not exceeding the limit value of the attached file send allowable data size of the mail server 104 is sent. Note that if the data size of the attached file exceeds the limit value of the attached file send allowable data size of the external mail server 106 to which the mail server 104 transfers the mail, a send error may occur, and the mail may not be sent. That is, assume that even if the file has the file size which can be sent by the mail server 104, the file size disables transfer of the file by the external mail server 106.

In this embodiment, a method will be described in which if file-attached mail exceeding the attached file send allowable data size of an intermediate external mail server 106 has failed to be sent, mail describing a file storage destination URL (position information) is sent.

[Software Arrangement]

A system configuration and hardware arrangement are the same as those in the second embodiment. A software arrangement different from that in the second embodiment will be described below.

Each unit of a mail send server 100 according to this embodiment will be explained with reference to FIG. 3. A mail reception unit 305 inquires of a mail server 104, and receives mail sent to the mail send server 100.

When a send error occurs for mail sent by the mail send server 100, a resend mail generation unit 306 generates mail to be resent. In this embodiment, a case in which a send error occurs includes a case in which a send error occurs since the size of a file attached to sent mail exceeds the send allowable data size of the external mail server 106 through which the mail passes before reaching a destination.

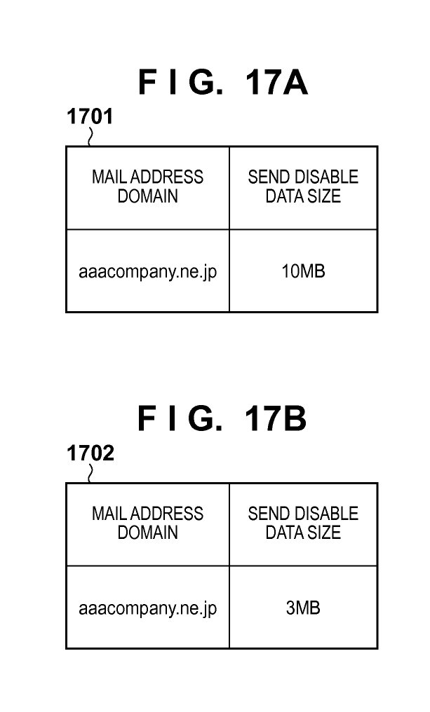

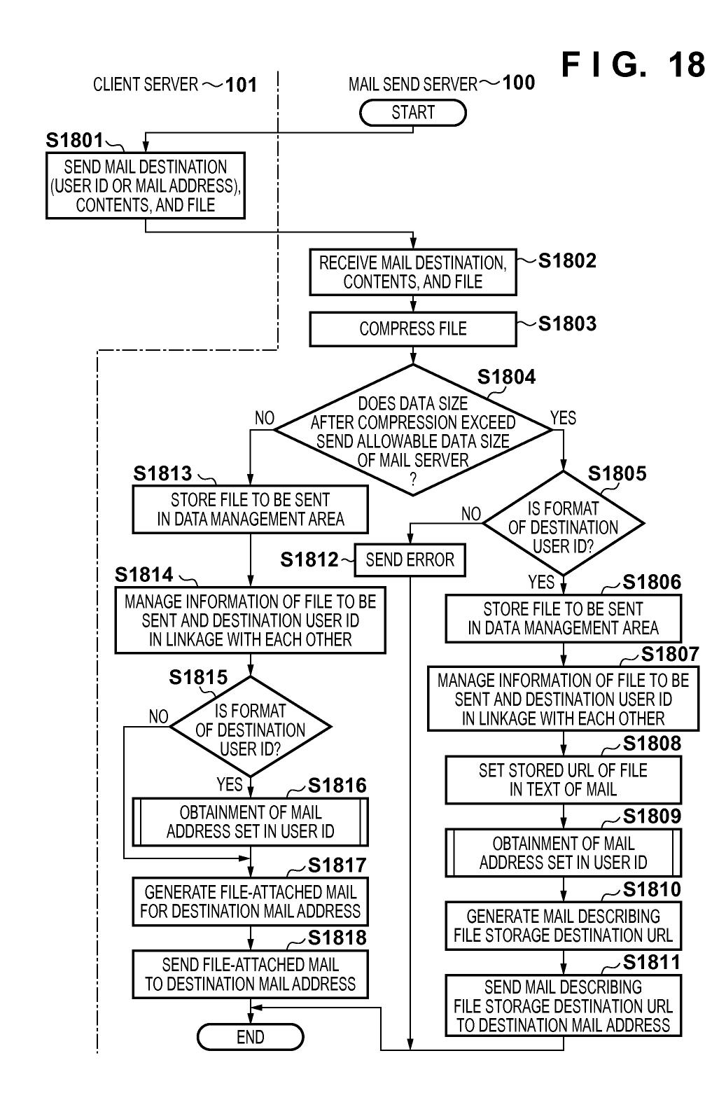

A mail server information management unit 309 holds, for each mail address domain, the data size of a file for which a send error has occurred, as indicated by a domain management table 1701 shown in FIG. 17A. The mail address domain and the data size of a file for which an error has occurred since the data size exceeds the send allowable data size of the mail server via which file-attached mail is sent to the domain are managed in association with each other. For example, the domain management table 1701 indicates a case in which an attempt to send a file having a data size of 10 MB to a mail address in a domain “aaacompany.ne.jp” results in a send error. In this state, if a file having a data size of 3 MB smaller than 10 MB could not be sent to a mail address in the domain “aaacompany.ne.jp”, the domain management table 1701 is updated to a domain management table 1702 shown in FIG. 17B.

A send mail information management unit 310 manages information about mail sent by the mail send server 100. As indicated by a mail send history table 1601 shown in FIG. 16, Message-ID for identifying mail, a destination, a subject, text, and a file ID for identifying a send target file are associated with each other. Other components are the same as those in the second embodiment and a description thereof will be omitted.

[File-Attached Mail Send Processing]

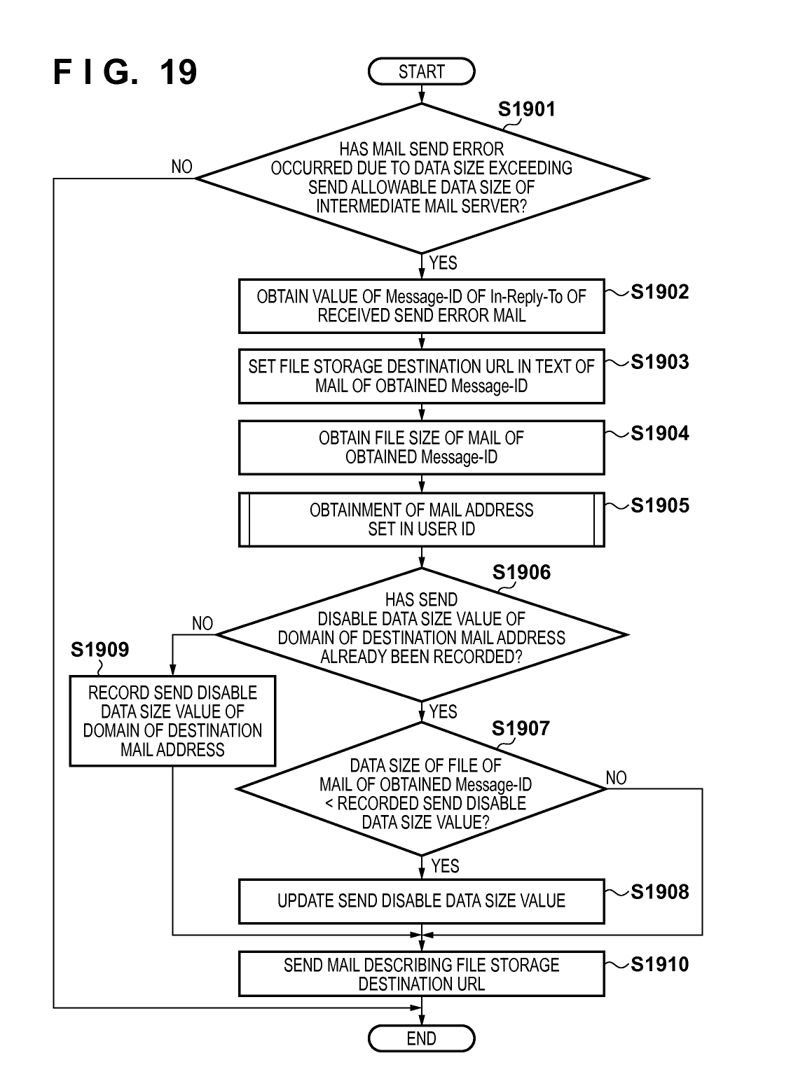

Processing of storing a file to be sent and sending a file-attached mail will be described with reference to a flowchart shown in FIG. 18. This processing is implemented when the CPU of each apparatus reads out and executes a program stored in a ROM or the like as a storage unit. Steps S1801 to S1812 are the same as steps S1301 to S1312 of FIG. 13 according to the second embodiment and a description thereof will be omitted.

S1813: A send file control unit 307 of the mail send server 100 stores a file to be sent in the send file storage unit 312.

S1814: The send file control unit 307 of the mail send server 100 records information of the file to be sent and the user ID of a destination in a file information management table 1201 shown in FIG. 12 in association with each other. Steps S1815 to S1818 are the same as steps S804 to S807 of FIG. 8 of the first embodiment and a description thereof will be omitted.

[Mail Resend Processing]

Processing of resending mail when the data size of an attached file exceeds the send allowable data size of the intermediate external mail server 106 will be described with reference to a flowchart shown in FIG. 19. This processing is implemented when the CPU of the mail send server 100 reads out and executes a program stored in a ROM or the like as a storage unit.

S1901: When the mail reception unit 305 sends file-attached mail, it is determined whether a mail send error occurs since the data size of an attached file exceeds the send allowable data size of the intermediate external mail server 106. In this example, when mail indicating a size error in the intermediate mail server is received from Mail-Darmon, it is determined that a send error has occurred. Note that known pieces of information are used as mail header information and error information, and the present invention is not specifically limited to them. If it is determined that a send error has occurred (YES in step S1901), the process advances to step S1902; otherwise (NO in step S1901), the process ends.

S1902: The resend mail generation unit 306 obtains the value of Message-ID recorded in In-Reply-To of the header of the send error mail received in step S1901.

S1903: The resend mail generation unit 306 specifies, from the mail send history table 1601, mail information indicated by Message-ID obtained in step S1902, and obtains the text of the mail information. The resend mail generation unit 306 then adds a file storage destination URL to the obtained mail text, thereby generating new mail text. For example, a case in which Message-ID shown in FIG. 16 is “20130507102030.A1B2C3@aaa.co.jp” will be exemplified. The resend mail generation unit 306 refers to the mail send history table 1601 to specify mail information 1602 having Message-ID “20130507102030.A1B2C3@aaa.co.jp”. The resend mail generation unit 306 then adds a file storage destination URL to the text (“I will send data.”) of the mail information 1602. The subject (“information”) of the mail information 1602 is set as the subject of the mail.

S1904: The resend mail generation unit 306 obtains, from the file information management table 1201, the data size of a file indicated by the file ID obtained in step S1903. As for the mail information 1602, a file ID is “File1”, and the file size (“3 MB”) of corresponding file information 1202 is obtained by referring to the file information management table 1201 of FIG. 12.

S1905: With the processing of FIG. 9, the mail address inquiry request unit 302 of the mail send server 100 obtains a mail address set in a target user ID.

S1906: The resend mail generation unit 306 confirms whether the domain of the destination mail address has already been recorded in the domain management table 1701. If the domain has been recorded (YES in step S1906), the process advances to step S1907; otherwise (NO in step S1906), the process advances to step S1909.

S1907: The resend mail generation unit 306 determines whether the data size of the file obtained in step S1904 is smaller than a send disable data size recorded in the domain management table 1701 determined in step S1906. If the data size is smaller than the send disable data size (YES in step S1907), the process advances to step S1908; otherwise (NO in step S1907), the process advances to step S1910.

S1908: The resend mail generation unit 306 updates the domain management table 1701 by setting the data size obtained in step S1904 as the send disable data size of the domain of the destination mail address. For example, as indicated by the domain management table 1701, assume that “10 MB” has already been recorded as the send disable data size of a mail address in the domain “aaacompany.ne.jp”. If the table is updated with “3 MB” smaller than “10 MB”, the domain management table 1702 of FIG. 17B is obtained. That is, the contents of the domain management table are updated according to the send result of a file-attached mail.

S1909: The resend mail generation unit 306 newly records, in the domain management table 1701, the data size obtained in step S1904 as the send disable data size of the domain of the destination mail address. If, for example, “10 MB” is newly recorded as the send disable data size of a mail address in the domain “aaacompany.ne.jp”, the domain management table 1701 of FIG. 17A is obtained. Processing in step S1910 is the same as that in step S1311 of FIG. 13 of the second embodiment and a description thereof will be omitted.

[Effects of Third Embodiment]

In the method according to the second embodiment, even if file-attached mail having a data size exceeding the limit value of the attached file send allowable data size of the intermediate external mail server 106 is sent, a send error occurs, and the sent mail does not reach a destination user. Therefore, the destination user may not obtain the send target file.

In the method according to this embodiment, in case that an attached file exceeds the send allowable data size of the intermediate external mail server 106, information of file-attached mail to be sent is stored in the mail send system in advance. When the file-attached mail has been sent, and a send error has occurred since the data size of the attached file exceeds the send allowable data size of the intermediate external mail server 106, the file-attached mail which has failed to be sent is specified, and mail describing a file storage destination URL is sent. Even if, therefore, the data size of the attached file exceeds the send allowable data size of the external mail server 106, mail is sent to a destination user, thereby enabling the user to obtain the file.

Furthermore, the mail send server 100 records and updates the information of the send allowable data size of the intermediate external mail server 106. By referring to the recorded information, the mail send server 100 determines whether to send the file-attached mail. When it is known in advance that even if file-attached mail is sent, the data size of the file exceeds the send allowable data size of the intermediate external mail server 106 and thus a send error occurs, mail describing a file storage destination URL is sent instead of attaching the send target file. Consequently, in addition to the effects of the first and second embodiments, it is possible to reduce the load of the mail server 104.

Embodiments of the present invention can also be realized by a computer of a system or apparatus that reads out and executes computer executable instructions recorded on a storage medium (e.g., non-transitory computer-readable storage medium) to perform the functions of one or more of the above-described embodiment(s) of the present invention, and by a method performed by the computer of the system or apparatus by, for example, reading out and executing the computer executable instructions from the storage medium to perform the functions of one or more of the above-described embodiment(s). The computer may comprise one or more of a central processing unit (CPU), micro processing unit (MPU), or other circuitry, and may include a network of separate computers or separate computer processors. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™, a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-163647, filed Aug. 6, 2013, which is hereby incorporated by reference herein in its entirety.

What is claimed is:

1. A system including a service server configured to provide a service, a mail send server configured to send mail, and an authentication server configured to perform authentication processing to use the service, comprising:
a management unit configured to manage, in said authentication server in association with each other, user identification information and a mail address which are used in said system;
a send unit configured to, if a user is authenticated by the authentication processing, send authorization information including user identification information of the user from said authentication server;
a reception unit configured to, upon receiving a request of the service together with the authorization information at said service server, receive a mail send request associated with the service and the user identification information included in the authorization information from said service server at said mail send server;
a specifying unit configured to, in response to reception of the mail send request associated with the service by said reception unit, specify a mail address associated with the user identification information included in the authorization information by inquiring of said authentication server; and
a mail send unit configured to send mail from said mail send server to the mail address specified by said specifying unit.

2. The system according to claim 1, wherein if said reception unit receives a mail send request associated with the service and a mail address from said service server, said mail send unit sends mail using the received mail address without specifying the mail address by said specifying unit.

3. The system according to claim 2, wherein it is possible to send mail associated with the service by attaching a file.

4. The system according to claim 3, further comprising
a unit configured to hold information of a size of a file capable of being sent by said mail send server,
wherein if a file of a size exceeding a send allowable file size is designated in the mail send request, said mail send unit sends mail containing storage position information of actual data of the designated file without attaching the designated file.

5. The system according to claim 4, wherein if said reception unit receives a mail send request associated with the service and a mail address from said service server and a file of a size exceeding a send allowable file size is designated, said mail send unit determines a send error.

6. The system according to claim 3, wherein if, as a result of sending mail attached with a file, mail send processing fails due to a size of the file, said mail send unit resends mail containing storage position information of actual data of the file without attaching the file.

7. The system according to claim 6, further comprising
a recording unit configured to, when said mail send unit sends mail attached with a file, record a size of the file and a destination of the mail in association with each other,
wherein said recording unit updates a file size which is not capable of being sent to the destination of the mail in accordance with a send result of the mail by said mail send unit.

8. The system according to claim 7, wherein if in the mail send request, a size of a file attached to mail destined for a designated destination exceeds a file size associated with the destination in said recording unit, said mail send unit sends mail containing storage position information of actual data of the file without attaching the file.

9. The system according to claim 1, further comprising
a unit configured to provide a reception screen which receives user identification information or a mail address as a mail send destination from the user.

10. A control method for a system including a service server configured to provide a service, a mail send server configured to send mail, and an authentication server configured to perform authentication processing to use the service, the method comprising:
a management step of managing, in the authentication server in association with each other, user identification information and a mail address which are used in the system;
a send step of, if a user is authenticated by the authentication processing, sending authorization information including user identification information of the user from the authentication server;
a reception step of, upon receiving a request of the service together with the authorization information at the service server, receiving a mail send request associated with the service and the user identification information included in the authorization information from the service server at the mail send server;
a specifying step of, in response to reception of the mail send request associated with the service in the reception step, specifying a mail address associated with the user identification information included in the authorization information by inquiring of the authentication server; and
a mail send step of sending mail from the mail send server to the mail address specified in the specifying step.

11. A non-transitory computer-readable medium storing a program for causing each computer, as each server in a system including a service server configured to provide a service, a mail send server configured to send mail, and an authentication server configured to perform authentication processing to use the service, to function as
a management unit configured to manage, in the authentication server in association with each other, user identification information and a mail address which are used in the system,
a send unit configured to, if a user is authenticated by the authentication processing, send authorization information including user identification information of the user from the authentication server,
a reception unit configured to, upon receiving a request of the service together with the authorization information at the service server, receive a mail send request associated with the service and the user identification information included in the authorization information from the service server at the mail send server,
a specifying unit configured to, in response to reception of the mail send request associated with the service by said reception unit, specify a mail address associated with the user identification information included in the authorization information by inquiring of the authentication server, and
a mail send unit configured to send mail to the mail address specified by the specifying unit.
